(19) United States
(12) Patent Application Publication
(10) Pub. No.: US 2025/0219759 A1
(43) Pub. Date: Jul. 3, 2025

(54) ADAPTIVE ENCODING AND DECODING OF INFORMATION FOR NETWORK AND APPLICATION FUNCTIONS

(71) Applicant: HUAWEI TECHNOLOGIES CO., LTD., SHENZHEN (CN)

(72) Inventors: Omar Ahmad Mohammad ALHUSSEIN, Kanata (CA); Maham BHATTI, Kanata (CA); Mehdi Arashmid AKHAVAIN MOHAMMADI, Kanata (CA)

(73) Assignee: HUAWEI TECHNOLOGIES CO., LTD., SHENZHEN (CN)

(21) Appl. No.: 19/086,728

(22) Filed: Mar. 21, 2025

Related U.S. Application Data
(63) Continuation of application No. PCT/CN2022/132827, filed on Nov. 18, 2022.

(51) Int. Cl. H04L 1/00; H04L 41/16

(52) U.S. Cl. CPC H04L 1/0033; H04L 41/16

(57) ABSTRACT

A communication network includes a first network element that has a neural network (NN) encoder with multiple NN encoder layers. The NN encoder is configured to generate a latent representation of input data observed at the first network element. The communication network also includes a second network element that has a NN decoder configured to decode the latent representation. The NN decoder has multiple NN decoder layers. The first network element obtains performance metric values of the NN decoder and communication network and determines, in accordance with the performance metric values, which of the NN encoder layers is to output the latent representation and which of the NN decoder layer is to receive the latent representation. Performance metric values indicative of un-desired (e.g., less than optimal) performance and network conditions may cause the first network element to output the latent representation from a different-size NN encoder layer and, correspondingly, to select a NN decoder layer that has the same size.

### CROSS REFERENCE TO RELATED APPLICATION

The present application is a continuation of Patent Cooperation Treaty Application Serial No. PCT/CN2022/132827, entitled “ADAPTIVE ENCODING AND DECODING OF INFORMATION FOR NETWORK AND APPLICATION FUNCTIONS,” filed on Nov. 18, 2022, the entirety of which is incorporated by reference herein.

### TECHNICAL FIELD

The present invention pertains in general to communication networks, such as core and access networks, and in particular to a method and system for optimizing resources in communication networks.

### BACKGROUND

Network optimization, traffic engineering, and mobile-edge computing rely on various (virtualized) network functions to optimize the resources of the network. Existing network functions, including traffic forecasting, traffic classification, traffic forwarding, anomaly detection, traffic conditioning, queue management, and packet scheduling, as well as emerging network functions related, for example, to real-time sensing and analytics in object detection and autonomous driving, can be implementable using optimization and model-free methods, such as machine learning. In addition, with fifth-generation (5G) technology and beyond, (over-the-top) application functions now can be hosted natively by a telecommunication service provider in the access and core networks in mobile-edge servers or in the cloud. It is desirable to optimize the communication and processing resources needed to support such application functions. For example, an application function hosted in the cloud can perform a photo enhancement for mobile users.

The performance of such network and application functions depends on timely and reliable information (e.g., parameters, features, data) from the network substrate. For example, an optimized traffic forwarding (or routing) network function enables steering traffic from source nodes to destination nodes while satisfying quality of service (QoS) requirements and other constraints. Sending information for various network and application functions can be resource-consuming and potentially hindered if the network is experiencing, for example, high demand or requires additional resources for or during maintenance.

Therefore, there is a need to provide a method and apparatus that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides methods and systems for obtaining and transferring data needed for supporting network and application functions in a communications network. More specifically, embodiments of the present disclosure provide methods, apparatus and systems used to adjust the size of a latent representation, encoded using a neural network (NN) encoder, to be transferred in the network for supporting (e.g., enabling, performing) at least one NN decoder performing a network or application functionality, in response to at least one performance metric value. The latent representation generated by the encoder represents the input data (features) of the encoder. The size of the latent representation may vary based on a specific encoder neural network layer at which a latent representation is generated by the encoder.

In various embodiments discussed herein, an encoder neural network (NN) layer at which a latent representation is generated is not selected but can be selected based on at least one performance metric value of a communication network. The latent representation generated at such corresponding encoder NN layer can be received by the decoder at a corresponding decoder NN layer based on a size of the latent representation. Non-limiting examples of performance metrics include a predictive performance of the decoder, a utilization rate of a link the communication network, a utilization rate of a wireless channel of the communication network, a measured contention for wireless access resources of the communication network, a delay associated to the communication network, and a congestion of the communication network.

In some embodiments, a distributed NN encoder-decoder system is deployed in the network. The NN encoder-decoder system may utilize machine learning to transfer and utilize data or information representative of or including the features for the at least one network or application function. The obtained data (or features) is processed using an NN encoder and transferred across the network to be decoded by an NN decoder) to perform the at least one network or application function. Obtaining such data may include (e.g. substantially automatically) selecting some or all data or features using a plurality of encoders deployed at respective network elements.

In an aspect of the present disclosure, there is provided a method, comprising actions performed at a first network element of a communication network. The first network element include a neural network (NN) encoder having NN encoder layers each configured to generate a respective output vector. The actions of the method include obtaining at least one performance value, and determining, in accordance with the at least one performance metric value, which of the NN encoder layers to use as an output layer of the NN encoder. The output vector of the output layer is a latent representation of input data input at the first network element. The actions of the method further include generating, with the NN encoder using the determined NN encoder layer as the output layer, the latent representation. The actions of the method further include providing the latent representation to a second network element of the network. The second network element includes a NN decoder configured to decode the latent representation to perform the at least one network or application function. The at least one performance value includes at least one of: a performance metric value indicative of a performance of the communication network; a predictive performance of the decoder in performing the at least one network or application function; a performance requirement of a slice of the communication network connecting the first network elements to the second network element; and a performance requirement of an application running on the first network element or the second network element.

In some embodiments, the at least one performance metric value includes at least one of a utilization rate of a link of the communication network, a utilization rate of a wireless channel of the communication network, a measured contention for wireless access resources of the communication network, a delay associated to the communication network, and a congestion of the communication network.

In some embodiments, determining which NN encoder layer to use as the output layer depends on a size of the respective output vector.

In some embodiments, the NN decoder has NN decoder layers, and the method further comprises providing the latent representation as input to one of the NN decoder layers that has a same size as the output layer of NN encoder.

In some embodiments, the NN decoder decodes the latent representation to do at least one of: obtain a prediction, obtain a classification, and reconstruct at least some of the input data to obtain reconstructed input data. In some embodiments, the communication network is controlled in accordance with at least one of: the prediction, the classification, and the reconstructed input data.

In some embodiments, the method further comprises actions performed at an additional network element of the communication network. The additional network element includes an additional NN encoder having additional NN encoder layers each configured to generate a respective output vector. The actions include obtaining at least one additional performance metric value, and determining, in accordance with the at least one additional performance metric value, which of the additional NN encoder layers to use as an output layer of the additional NN encoder, the output vector of the output layer of the additional NN encoder being an additional latent representation of additional communication input data at the additional network element. The actions also include generating, with the additional NN encoder using the determined additional NN encoder layer as the output layer of the additional NN encoder, the additional latent representation, and providing the additional latent representation to the second network element, the second network element being configured to decode the additional latent representation.

In another aspect, the present disclosure provides a method that comprises obtaining, by a first network element of a communication network having an encoder with neural network (NN) encoder layers, input data at the first network element. The method further comprises generating, by the encoder, at one of the NN encoder layers, a latent representation of the input data, and providing, by the first network element, the latent representation to a second network element of the communications network, the second network element having a decoder with NN decoder layers. The method additionally comprises receiving, by the decoder the latent representation at a NN decoder layer that has a same size as the NN encoder layer that generated the latent representation, and decoding, by the decoder, the latent representation. The method may further comprise receiving, by the decoder the latent representation at a NN decoder layer that has a same size and a same depth as the NN encoder layer that generated the latent representation. In the context of the present disclosure, the depth of a NN layer in a NN encoder is the position of NN layer starting from the input layer and, the depth of a NN layer in a NN decoder is the position of the NN layer starting from the output layer.

In some embodiments, the NN decoder decodes the latent representation to do at least one of: obtain a prediction, obtain a classification, and reconstruct at least some of the input data to obtain reconstructed input data.

In some embodiments, the communication network is controlled in accordance with at least one of: the prediction, the classification, and the reconstructed input data.

In some embodiments, the method further comprises obtaining, by the first network element, performance values. The performance values include at least one of: a performance metric value indicative of a performance of the communication network, a predictive performance of the decoder in generating the at least one network or application function, a performance requirement of a slice of the communication network connecting the first network element to the second network element, and a performance requirement of an application running on the first network element or the second network element. The method further comprises selecting the one of the NN encoder layers to generate the latent representation, in accordance with the performance values.

In some embodiments, the at least one performance metric value indicative of the performance of the communication network includes at least one of a utilization rate of a link the communication network, a utilization rate of a wireless channel of the communication network, a measured contention for wireless access resources of the communication network, a delay associated to the communication network, and a congestion of the communication network.

In some embodiments, generating the latent representation by the encoder, at the selected encoder NN layer, in response to said receiving the decoder performance indication, results in a change in the predictive performance of the decoder.

In some embodiments, the performance metric value indicative of the performance of the network comprises an indication of the network failure in meeting a performance criteria. The generating of the latent representation, by the encoder, at the selected encoder NN layer, in response to said indication of the network failure in meeting the performance criteria, results in the network approaching the performance criteria.

In some embodiments, the method further comprises computing, by an orchestrator deployed at the communications network, at least one performance metric value representative of at least one or a combination of: a performance of the network, and the predictive performance of the decoder. The method additionally comprises providing, by the orchestrator to the encoder network element, an indication of the selected encoder NN layer based on the at least one performance metric value, and generating, by the encoder, the latent representation at the selected encoder NN layer based at least in part on the indication of the selected encoder NN layer.

In some embodiments, computing by the orchestrator of the at least one performance metric value comprises: receiving a decoder performance indication when the predictive performance of the decoder fails to meet a predetermined threshold.

In some embodiments, the performance metric value indicative of the performance of the communication network comprises an indication of available network resources for supporting at least one or a combination of: sending by the first network element the latent representation to the second network element and receiving by the decoder the latent representation at the NN decoder layer that has the same size as the NN encoder layer that generated the latent representation.

In some embodiments, the method comprises obtaining, by a latent representation module deployed at the second network element, the latent representation, and receiving, by the decoder, the latent representation at the NN decoder layer that has the same size as the NN encoder layer that generated the latent representation.

In some embodiments, the method comprises obtaining, by an orchestrator deployed in the communications network and from the first network element, a latent representation indication, indicative of a NN encoder layer that generated the latent representation. The method additionally comprises providing, by the orchestrator to the second network element, an indication of a decoder NN layer based on the latent representation indication, and receiving, by the decoder, the latent representation at the decoder NN layer based on the indication of the decoder NN layer.

In some embodiments, the predictive performance of decoder comprises a history of performance of the decoder, the history being stored on a memory or in a database of the communication network.

In some embodiments, the predictive performance of the decoder comprises key network or application function performance indicators for performing, by the decoder, at least one network or application function.

In some embodiments, the input data includes at least one of sensing data generated by a sensor coupled to the communication network and analytics data generated by an analytics module coupled to the communication network.

In a further aspect of the present disclosure, there is provided a communication network that comprises a first network element having a neural network (NN) encoder having NN encoder layers each configured to generate a respective output vector. The first network element is configured to obtain at least one performance metric value of the communication network, and to determine, in accordance with the at least one performance metric value, which NN encoder layer output vector to use as a latent representation of input data at the first network element. The first network element is also configured to generate, with the NN encoder using the determined NN encoder layer, the latent representation of the input data. The system further comprises a second network element configured to receive the latent representation. The second network element has a NN decoder configured to decode the latent representation. The at least one performance value includes at least one of: a performance metric value indicative of a performance of the communication network, a predictive performance of the decoder in generating the at least one network or application function, a performance requirement of a slice of the communication network connecting the first network elements to the second network element, and a performance requirement of an application running on the first network element or the second network element.

In some embodiments, the at least one performance metric value indicative of the performance of the communication network includes at least one of: a utilization rate of a link of the communication network, a utilization rate of a wireless channel of the communication network, a measured contention for wireless access resources of the communication network, a delay associated to the communication network, and a congestion of the communication network.

In some embodiments, determining which NN encoder layer output vector to use as the output layer depends on a size of the NN encoder layer output vector.

In some embodiments, the NN decoder has NN decoder layers, the first network element is configured to identify, to the second network element, which of the NN decoder layers is to receive the latent representation, and the identified NN decoder layer has a same size at the NN encoder layer whose output vector is used as the latent representation.

In some embodiments, the NN decoder is configured to decode the latent representation to do at least one of: obtain a prediction, obtain a classification, and reconstruct at least some of the input data.

In a further aspect of the present disclosure, there is provided a computer program product comprising instructions which, when executed by a computer, cause the computer to implement the method of any one of the aforementioned embodiments or aspects.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 shows a schematic of an NN encoder-decoder structure.

FIG. 2 shows an encoder-decoder system.

FIG. 3 shows a modified version of the encoder-decoder system shown at FIG. 2.

FIG. 4A shows a block diagram of an embodiment of an encoder-decoder system according to the present disclosure.

FIG. 4B shows a block diagram of another embodiment of an encoder-decoder system according to the present disclosure.

FIG. 4C shows a block diagram of yet a further embodiment of a system according to the present disclosure.

FIG. 4D shows a block diagram of yet another embodiment of a system according to the present disclosure.

FIG. 5A shows a flowchart of an embodiment of a method in accordance with the present disclosure.

FIG. 5B shows a flowchart of another embodiment of a method in accordance with the present disclosure.

FIG. 6 shows a further embodiment of a system in accordance with the present disclosure.

FIG. 7 shows a user equipment unit connected to a base station through a legacy C/U plane connection, with the user equipment also connected to mm-Wave station through a mm-wave U-plane connection.

FIG. 8 shows yet another embodiment of a system in accordance with the present disclosure.

It will be noted that throughout the appended drawings, like features are identified by like reference numerals.

### DETAILED DESCRIPTION

In the context of the present disclosure, an element A can be said to be coupled to an element B when element A is configured to provide a signal (e.g., a wireless signal, an electrical signal, etc.) to element B or element B is configured to obtain the signal from element A. Element A may also be said to be coupled to an element B when element A is configured to receive a signal (e.g., a wireless signal, an electrical signal, etc.) from element B or element B is configured to provide the signal to element A. Element A may also be said to be coupled to an element B when a change in a parameter at element A results in a change in parameter at element B. Element A may be said to be coupled to element B when element A and element B are in communication with each other or when they are connected to each other.

In the context of the present disclosure, the size of a vector (output vector, latent representation, code) is to be understood as meaning the number of elements in the vector.

The present disclosure provides methods and systems for obtaining and transferring data needed for supporting network functions, application functions or both, in a communications network. More specifically, embodiments of the present disclosure pertain to methods, apparatus and systems used to adjust the size of a latent representation, encoded using an encoder, to be transferred in the network for supporting (e.g., enabling, performing) at least one network or application function, in response to at least one performance metric value. The latent representation generated by the encoder represents the input data (features) input into the encoder. The size of the latent representation may vary based on a specific encoder neural network layer at which a latent representation is generated by the encoder. In the context of the present disclosure, input data may encompass, for example, flows metadata, measured sensor data, measured physical channel data, measured performance data, etc. Input data may also include data unrelated to the communication network or system.

In various embodiments discussed herein, an encoder neural network (NN) layer at which a latent representation is generated is not predetermined but can be selected based on at least one performance metric value of a communication network. The latent representation generated at such corresponding encoder NN layer can be received by the decoder at a corresponding decoder NN layer based on a size of the latent representation, which is in correspondence with the depth of the encoder NN layer that generated the latent representation. Non-limiting examples of performance metrics include a utilization rate of a link the communication network, a utilization rate of a wireless channel of the communication network, a measured contention for wireless access resources of the communication network, a delay associated to the communication network, and a congestion of the communication network.

In some embodiments, a distributed encoder-decoder system is deployed in the network. The encoder-decoder system may utilize machine learning to transfer and utilize data or information representative of or including the features for the at least one network or application function. The obtained data (input data or features) is processed (e.g. encoded, compressed) and transferred across the network to be decoded (and decompressed if previously compressed) to support (or enable, perform) the at least one network or application function. Obtaining such data may include (e.g. substantially automatically) selecting some or all data or features using a plurality of encoders deployed at respective network elements.

FIG. 1 shows a schematic of an NN encoder-decoder structure 20. An encoder 22 includes a first layer, which is an input layer 24, at which input features are provided, and n hidden encoder layers 26. The input features provided at the input layer 24 may be said to form an input vector. When all the encoder layers (i.e., the input layer 24 and the hidden layers 26) finish encoding the data (features) provided at the input layer 24, the encoder 20 generates a latent representation 28 (also known as a code or an embedding) of the data. The latent representation 28 has a corresponding length (size) 30. A decoder 32, comprised of m decoder layers 34 and an output layer 36, receives and processes the latent representation 28 to obtain decoded data, that includes some or all of the data provided at the input layer 24, at the output layer 36. Such an encoder-decoder structure 20 may be trained (e.g., via machine learning, deep learning, deep reinforcement learning) to obtain selected data at the encoder input layer 24. The decoded data generated by the decoder 32 at the output layer 36 may be substantially identical to the selected input data (input features) and therefore define or include features (parameters) that are substantially the same as the input features (parameters). The decoded data may represent or include only some of the features defined by or included in the selected data at the input layer. Thus, an encoder may be configured (e.g. trained) to obtain (e.g. select, filter out), at the input layer, selected input data (input features) that defines, includes or represents specific network or application function features (parameters) for at least one network or application function, while a decoder may be configured (e.g. trained) to obtain (e.g. extract, decode), at its output layer, data that defines, represents or includes some or all of the specific network or application function features for the at least one network or application function. In some embodiments, the decoder may be configured to decode the latent representation to obtain a prediction, a classification or a reconstruction of some of the input data.

Each layer of the encoder 22 can be said to generate a vector (an output vector) to be used as input for the next layer of the encoder 22. The latent representation 28 can be said to be the output vector of the last hidden layer of the encoder 22. More broadly, the output vector of any particular layer of the encoder 22 may be said to be the latent representation of the features/data input into the particular layer. The size of a vector generated and output by a particular layer of the encoder 22 may be the same or may be smaller than the size of the vector that was input into the particular layer.

Similarly, each layer of the decoder 32 can be said to generate an output vector to be used as input for the next layer of the decoder 32. The latent representation 28 can be said to be the input vector of the first hidden layer of the decoder 32. More broadly, the output vector of any particular layer of the decoder 32 may be said to be the latent representation of the features/data input into the particular layer. The size of a vector generated and output by a particular layer of the decoder 32 may be the same or may be larger than the size of the vector that was input into the particular layer.

In embodiments, an encoder-decoder system includes at least one (neural network or NN) encoder. The encoder-decoder system may include a plurality of encoders deployed in the network. Each encoder encodes (e.g., periodically, or substantially continuously) some or all network function features (or data including or representative thereof) at an associated or respective network element (which may be referred to as an encoder network element) at which the encoder is deployed to generate a latent representation. An encoder may process data obtained at the encoder network element. Such processing may include selecting (e.g., filtering) data required or needed for at least one network or application function. The latent representation may be further reduced in length or size (i.e., compressed) using an optional compression module deployed at the same associated or respective encoder network element.

In embodiments, all encoder NN layers of an encoder may be implemented at a single network element. In other embodiments, some encoder NN layers may be deployed at more than one network element.

In embodiments, at least one (neural network or NN) decoder is deployed at an associated or respective network element (which may be referred to as a decoder network element). Each decoder is configured (e.g. trained) to obtain (e.g. via decoding) at least those (output) features from the latent representation that are needed to support (e.g. facilitate, implement, perform, enable), by the decoder, at least one network or application function associated with the decoder. Such features (or data representative of or including such features) may be referred to as network or application function features or output features and may include some or all features included in the latent representation received by the decoder from at least one encoder. A decoder may be configured to provide the (decoded) network or application function features to an external component (a network element) that supports or performs the network function replying on said network function features.

In some embodiments, a decoder may support more than one network or application function. In such cases, each network or application function supported by the same decoder may rely on substantially the same output features. In another case, a network or application function A may rely on a set of network or application function features A and a network or application function B may rely on a set of network or application function features B, the network or application function features B being a subset of the network or application function features A and thus output features that include features A would also include features B. In another example, the decoder may obtain from the latent representation substantially different network or application function features for each of the network or application function associated with the decoder. The decoder may support a specific network or application function based on the network or application function features obtained from the latent representation. If the obtained network or application function features do not sufficiently correspond to the features needed for a specific network or application function, then the decoder may, for example, obtain such features from another one or more latent representation received from one or more encoder (or associated encoder network element).

The present disclosure describes how to tune/control the amount of information transferred between NN encoders and NN decoders and the associated signaling overhead, depending on the network conditions.

The network conditions can be a function of the availability of network resources, required/measured quality of service metrics of certain flow. For example, it may be required for the encoder to reduce the amount of information being sent to the decoder when the network is experiencing congestion to avoid bottlenecking signaling paths/links. In some embodiments of the present disclosure, this may be achieved by measuring the network and traffic conditions, and selectively which hidden layer's output from the encoder to transmit.

The encoder-decoder hyper-parameters (i.e., number of layers, number of nodes, learning rate, etc.) may be optimized through hyperparameter search or tuning to provide the best achievable performance. As will be understood by the skilled worker, hyperparameters are the training and modeling configuration parameters that are not directly learned from the training set. For example, feed-forward neural network model parameters are the weights and bias values of the neurons which are learned from the training set. Non-inclusive examples of model hyperparameters are learning rate, batch size, number of layers, and number of nodes.

FIG. 2 shows a network element 23 and a network element 33. The network element 23 includes an encoder 22 and the network element 33 includes a decoder 32. The encoder 22 is coupled to the decoder 32 through a network 38. The encoder 22 and the decoder 32 form an optimized pair. The encoder 22 includes layer 1 40, layer 2 42 and layer 3 44. The encoder 22 is configured to output a latent representation (code) C 46. The decoder 32 includes layers 4 48, layer 5 50 and layer 6 52. It can be said that the encoder 22 is deployed at the network element 23 and that the decoder 32 is deployed at the network element 33.

By adding a lower size NN layer at the output of layer 3 44, the modified encoder-decoder becomes less optimal since adding an additional bottleneck layer loses information (or features) as a result of further imposed compression. FIG. 3 shows a modified version of the encoder-decoder system shown at FIG. 2. In FIG. 3, additional layer 7 54 is added at the output of layer 3 44. The output of layer 7 54 is the latent representation C′ 56. FIG. 3 also shows layer 8 58 added at the input of the decoder 32, prior to layer 4 48. Here, by definition, the entropy H of C′ 56 is lower than that of C 46 (i.e., H(C′)<H(C)).

Consequently, the latent representation C′ 56 can be represented/encoded with fewer bits than the latent representation C 46. Because H(C′)<H(C), the decoder's performance when receiving the latent representation C′ 56 (FIG. 3) is at most equal or worse than the decoder's performance receiving the latent representation C 46 (FIG. 2).

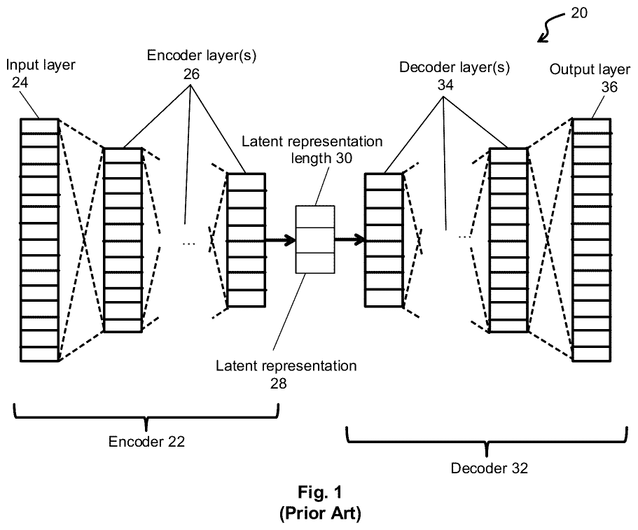

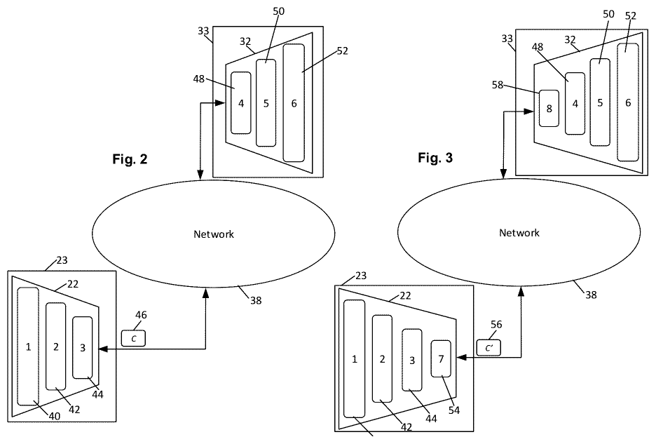

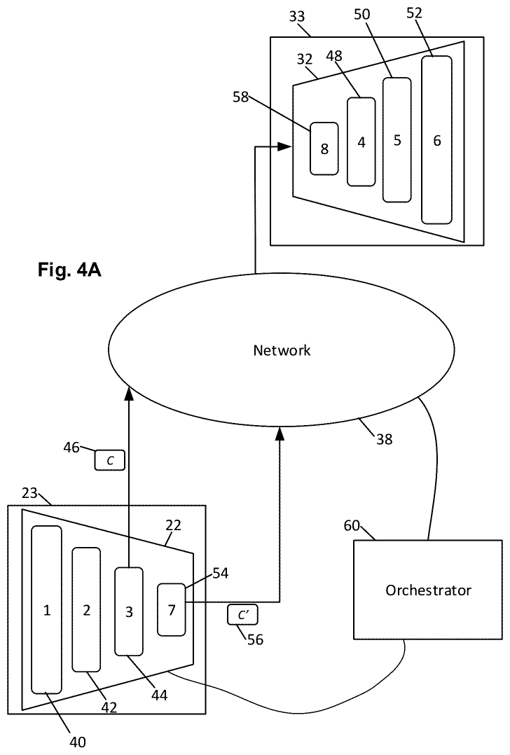

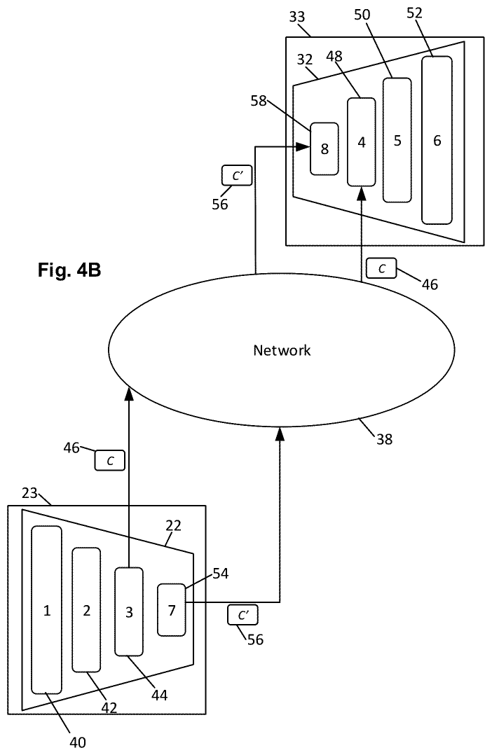

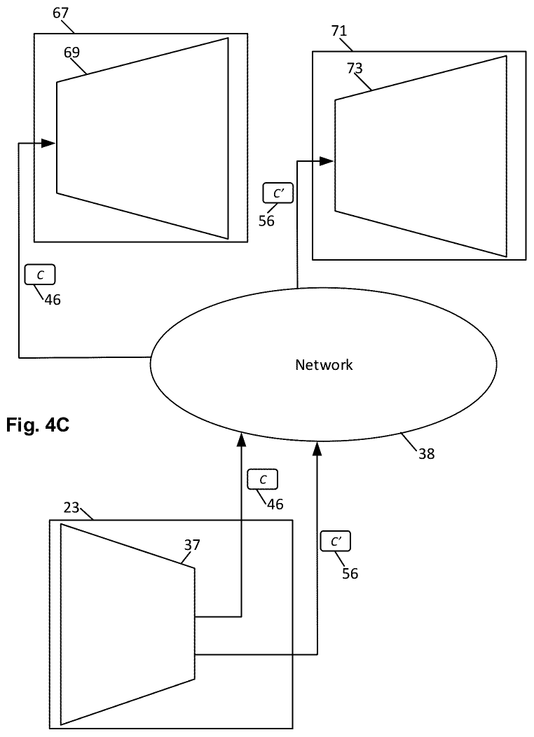

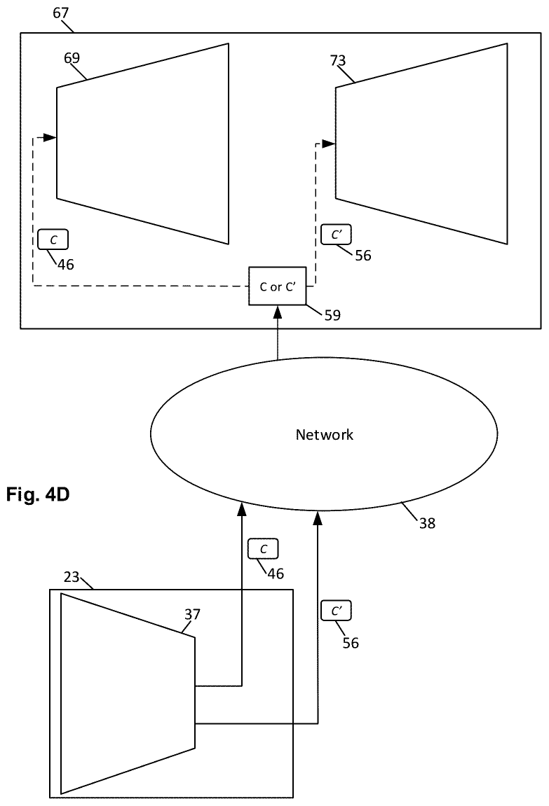

FIG. 4A shows a block diagram of an embodiment of the present disclosure. In this embodiment, the system may be configured to have the encoder 22 (or network element 23) selectively provide either the latent representation C 46 or C′ 56 to the decoder 32 (or network element 33), through the network 38. When the latent representation C 46 is provided to the decoder 32, it is provided to layer 4 48. When the latent representation C′ 56 is provided to the decoder 32, it is provided to layer 8 58.

In embodiments of the present disclosure, the system of FIG. 4A may include an orchestrator 60 coupled to the encoder 22, the network 38 and the decoder 32. The orchestrator 60 may also be referred to as a controller and may be configured to decide which of the latent representation C 46 or the latent representation C′ 56 may be sent from the encode 22 to the decoder 32. The orchestrator 60 may be configured to obtain from a network authority (oracle) key-performance indicators (KPIs) for each network or application function output by the decoder 32. The KPIs may include threshold performance criteria that are to be met by the decoder 32. The orchestrator 60 may be deployed in any network element. In some embodiment, the orchestrator may be deployed (installed) close to where decoders are deployed, as the network functionalities performed by the decoder are beneficial to centralized control units and orchestrators.

To decide which of the latent representation C 46 or the latent representation C′ 56 should be sent from the encoder 22 to the decoder 32, the orchestrator 60 may observe the output of the decoder 32 (e.g., the values of the network or application functions output by the decoder 32), measure or receive the ground truth, or compute a predictive performance of the decoder 32. This task of computing the predictive performance of the decoder may be performed by the decoder 32 itself. The orchestrator 60 may also observe network conditions such as by measuring the congestion, quality of service, and other performance metrics of certain network elements of the network 38, including those of paths or flows within the network 38. The performance metrics to observe may be scenario-dependent and/or application-dependent. In some embodiments, the orchestrator 60, may instruct the network element that includes the encoder 22 to transmit either C 46 or C′ 56.

For example, in some embodiments, the orchestrator 60 may measure the average utilization of the control channels or paths that overlap with in-band control channels. If the average utilization is below a certain level, it may instruct the encoder 22 (or the network element at which the encoder 22 is deployed) to send the latent representation C 46. Otherwise, the orchestrator 60 may instruct the encoder 22 (or the network element at which the encoder 22 is deployed) to send the latent representation C′ 56, while ensuring that the performance of the decoder 32 meets its related performance criteria.

In other embodiments, the orchestrator 60 may not be required and the determination of whether the encoder 22 should send the latent representation C 46 or the latent representation C′ 56 to the decoder 32 may be performed in a peer-to-peer manner between the encoder 22 and the decoder 32. In this case, the network element(s) containing the encoder and decoder may perform the tasks of the orchestrator 60 and coordinate among each other. For example, the decoder 32 may be configured to obtain, from a network authority (oracle), key-performance indicators (KPIs) for each network or application function output by the decoder 32. The KPIs include threshold performance criteria that are to be met by the decoder 32. The decoder may also measure or receive the ground truth and compute performance of the decoder 32. As for the network element containing the encoder 22, it may be configured to observe network conditions such as by measuring the congestion, quality of service, and other performance metrics of certain network elements of the network 38, including those of paths or flows within the network 38. The performance metrics to watch for may be scenario-dependent and/or application-dependent. In some embodiments, the encoder 22, may instruct the network element 23 that includes the encoder 22 to transmit either C 46 or C′ 56.

In other embodiments according to the present disclosure, there may be more than two different latent representations that may be provided by an encoder to a decoder. FIG. 4B shows a variant of the system of FIG. 4A in accordance with the present disclosure. In the system of FIG. 4B, both the latent representation C 46 and the latent representation C′ 56 are provided to the decoder 32 respectively at layer 4 48 and at layer 8 58.

In other embodiments according to the present disclosure, a first network element may include an encoder configured to output two latent representations, a second network element may include a respective decoder configured to receive one of the two latent representations, and a third network element may include a respective decoder configured to receive the other of the two latent representations. That is, each respective decoder is tuned (configured) to decode a distinct respective latent representation generated at the first network element. FIG. 4C shows such an embodiment of a system according to the present disclosure. In FIG. 4C, the first network element 23 includes a first encoder 37 configured to output the latent representation C 46 or to output the latent representation C′ 56. The system of FIG. 4C comprises a network element 67 that includes a decoder 69 configured to decode the latent representation C 46. Additionally, the system of FIG. 4C comprises a network element 71 that includes a decoder 73 configured to decode the latent representation C′ 56. Network element 23 is coupled to the network element 67 and to the network element 69, through the network 38.

In additional embodiments according to the present disclosure, a first network element may include an encoder configured to output two latent representations of different sizes, and a second network element may include two decoders. Each of the two decoders may be configured to receive and decode one of the two latent representations generated at the first network element. That is, each respective decoder of the second network element is tuned (configured) to decode a distinct respective latent representation generated at the first network element. FIG. 4D shows an embodiment where the first network element 23 includes a first encoder 37 configured to output the latent representation C 46 or to output the latent representation C′ 56. Examples of how the network element 23 decides to output C 46 or C′ 56 are provided elsewhere in the present disclosure. The system of FIG. 4D also comprises a network element 67 that includes a decoder 69 configured to decode the latent representation C 46 and a decoder 73 configured to decode the latent representation C′ 46. The network element 23 is coupled to the network element 67 through the network 38. The network element 67 also includes a module 59 configured to determine which of C 46 or C′ 56 is received from the network 38. When C 46 is received, the module 59 provides it to the decoder 69. When C′ 56 is received, the module 59 provides it to the decoder 73. In some embodiments, the module 59 determines the size of the latent representation (of the vector representing the latent representation) received from the network 38 and forwards the latent representation to the decoder configured to receive a latent representation of the same size.

As will be understood by the skilled worker, embodiments of the present disclosure may be deployed in core networks and/or in access networks.

For architectures involved in core networks (or wired networks), encoders (or the first network element in embodiments of the present disclosure) may be implemented in network switches, routers, middleware or commodity servers. Each decoder may be trained to perform a network or application function (network or application functionality) such as, but not limited to, traffic prediction, traffic forwarding, anomaly detection, packet classification, or input data reconstruction. Multiple encoders may be coupled to a single decoder to provide a network or application function. The decoder (or the second network element in embodiments of the present disclosure) may be deployed in a network element such as network switch, router, middleware, or a commodity server. An example of traffic prediction-based encoder-decoder scenario is given in one of the embodiments.

For architectures involved in access networks (or wireless networks), encoders (or the first network element in embodiments of the present disclosure) and/or decoders (or the second network element in embodiments of the present disclosure) may be implemented in user equipment (e.g., mobile devices) or access network node (e.g. base stations), wherein the access network node may be baseband units, mobile-edge and data center servers or computing elements, including commercial-off-the-shelf computing hardware platforms and specialized hardware computing platforms. Decoders may be trained to perform a network or application functionality (network or application function) such as mobility prediction, power prediction/estimation, mm-wave based throughput prediction, traffic prediction, packet scheduling. An example of mmWave-based throughput prediction-based encoder-decoder scenario is given in one of the embodiments.

In some embodiments, encoders and decoders may be implemented as neural networks in switches and/or routers. Therefore, when a switch contains an encoder or decoder, AI based chips may be present.

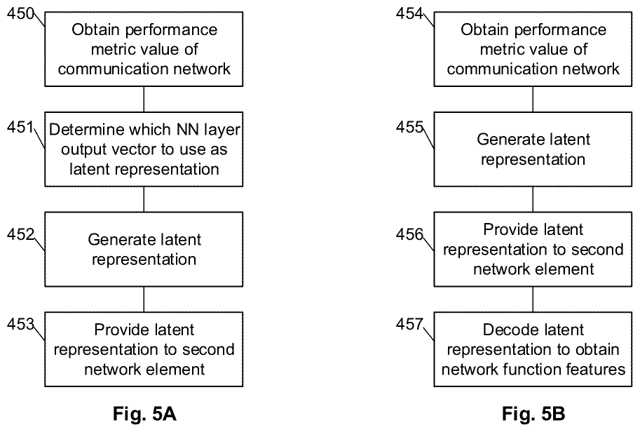

FIG. 5A shows a flowchart of an embodiment of a method in accordance with the present disclosure. The method shown in FIG. 5A shows actions taken by various components of an encoder-decoder system, according to an embodiment of the present disclosure. At action 450, a first network element of a communication network obtains a performance metric value (multiple performance metric values) of the communication network. The first network element has a NN encoder deployed thereat and the NN encoder has NN encoder layers each configured to generate an output vector. At action 451, the first network element (the encoder deployed thereat) determines, in accordance with the performance metric value obtained at 451, which NN encoder layer output to use as a latent representation of input features (input data) obtained (observed, received) at the first network element. At action 452, the encoder generates the latent representation in accordance with the NN encoder layer output determined at 451. At action 453, the first network element (the encoder deployed thereat) provides the latent representation to a second network element that has a decoder deployed thereat. The decoder is configured to decode the latent representation.

In some embodiments, the performance metric value may include, for example, a value of: a utilization rate of a link of the communication network, a utilization rate of a wireless channel of the communication network, a measured contention for wireless access resources of the communication network, a delay associated to the communication network, a congestion of the communication network, or any combination thereof.

FIG. 5B shows a flowchart of another embodiment of a method in accordance with the present disclosure. The method shown in FIG. 5B shows actions taken by various components of an encoder-decoder system, according to an embodiment of the present disclosure. At action 454, a first network element of a communication network obtains features of the communication network that encompasses the first network element. The first network element has a NN encoder deployed thereat and the NN encoder has NN encoder layers each configured to generate an output vector, which may be used as a latent representation of the features of the communication network. The NN encoder has an input layer configured to receive the features of the communication network obtained at the first network element. At action 455, the NN encoder deployed at the first network element generates, at one of the NN encoder layers, a latent representation of the features of the communication network. At action 456, the first network element provides the latent representation to a second network element of the communication network. The second network element has a decoder deployed thereat and the decoder has consecutive NN decoder layers. At action 457, the decoder deployed at the second network element receives the latent representation at a NN decoder layer that has a same depth and a same size as the NN encoder layer that generated the latent representation. At action 457, the decoder decodes the latent representation.

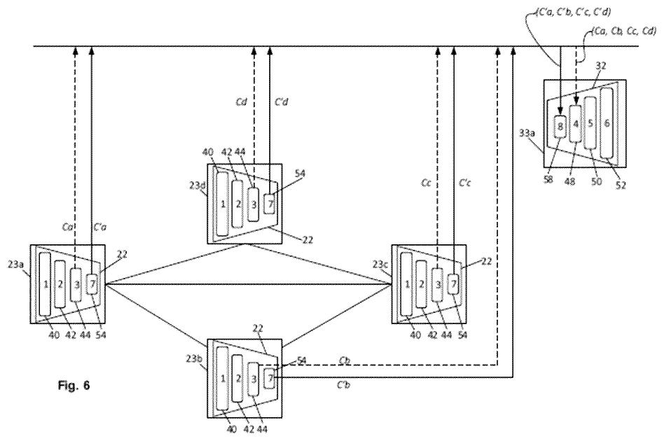

FIG. 6 shows an embodiment of a system in accordance with the present disclosure. The embodiment of FIG. 6 relates to an encoder-decoder based traffic forecasting network or application function. The system of FIG. 6 may comprise four network elements (23a, 23b, 23c and 23d), each of which may have a respective encoder 22, which may each include layer 1 40, layer 2 42, layer 3, 44 and layer 7 54. The network elements (23a, 23b, 23c and 23d) may be coupled to each other directly or indirectly. The embodiment of FIG. 6 may also comprise a network element 33a, which may include a decoder 32, which may include layer 8 58, layer 4 48, layer 5 50 and layer 6 52. In this embodiment, the network or application function performed by the decoder 32 is configured to predict, every hour (for example), the amount of available resources for each link interconnecting the network elements 23a, 23b, 23c and 23d. The decoder 32 receives data from the encoders 22 every 3 hours and generates a prediction of the amount of resources available every 3 hours. The input to each encoder 22 may comprise the average bit rate per second sampled every few minutes, and the average packet rate per second sampled every few minutes. Other feature types may also be included.

For the same time step, each encoder 22 of the network elements 23a, 23b, 23c, and 23d may each output either a fixed-length vector of a same length (e.g., L) from the last layer (layer 7 54), or a fixed-length vector of another same length (e.g., L+X) from layer 3 44. The same-length vectors output from each respective layer 7 54 are vectors Ca, Cb, Cc and Cd. The same-length vectors output from the respective layer 3 44 are C′a, C′b, C′c and C′d. The decoder 32 of the network element 33a may continuously monitor for traffic congestion in the network. If traffic congestion (in the data plane or control plane) is tolerable (e.g., as determined by comparing to certain threshold criteria), the encoders 22 send the output of the layer providing the most informative code, i.e., the output vector from layer 3 44, such that the decoder 33 receives the vectors Ca, Cb, Cc and Cd at layer 4 48. If traffic congestion is increased beyond a certain threshold, the decoder instructs the encoders 22 to send a less-informative code e.g., from layer 7, such that the decoder 33 receives the vectors C′a, C′b, C′c and C′d at layer 8 58. Here, traffic congestion or other metrics may be measured and reported by each encoder 22 to the decoder 32 or to an orchestrator when present. Alternatively, the decoder or an orchestrator can actively probe the network or parts of it to measure the network congestion.

The embodiment of FIG. 6 may include a variation where the decoder 33 may not only decides to switch between C and C′ by measuring/observing/receiving information about the traffic conditions, but also by monitoring its own prediction performance (e.g., by measuring its mean square error). Here, the decoder 33 may receive individual error metrics from each encoder 22a, 22b, 22c and 22d or can receive information about the ground truth and compute the error metric.

In another variation of the embodiment shown in FIG. 6, some of the instructions and measurements performed by the encoders/decoder may be performed by a central entity (an orchestrator).

Although the embodiment of FIG. 6 specifically addresses a traffic forecasting (prediction) network or application function, other embodiments within the scope of the present disclosure may extend to other network or application functions that can benefit from global view/knowledge of the network such as traffic forwarding, traffic classification, input data reconstruction and anomaly detection.

In other embodiments, in addition to legacy connections to macro base stations (BSs), current 5G based network architectures may add several millimeter-wave (mm-wave) BSs. Here, the user may get user-plane (U-plane) connections with high throughput via mm-wave BSs while having a reliable control-plane (and user-plane) connection with a macro-BS. Mm-wave based connections are useful for services that require very high throughput such as real-time augmented/virtual reality gaming. FIG. 7 shows an embodiment where a user equipment (UE) unit 62 is connected to a BS 64 through a legacy C/U plane connection 66 and where the user equipment 62 is also connected to mm-Wave station 68 through a mm-wave U-plane connection 70. In the embodiments of the present disclosure, “user” could also be called “user equipment (UE)”.

As mm-wave based beams are highly directed, mobile users experience highly- and widely-varying throughput that correlates with temporal and spatial features at the location where the mm-wave connection is established the scene. Many factors, such as position of the user, proximity of contending users to each other, static and dynamic obstacles, user's movement patterns and direction, angle of the UE, received power, and height of the user may have an effect on the measured throughput. Throughput prediction is useful for over-the-top applications or service slices being used by the user, such as video streaming, real-time gaming, and virtual reality. For example, video streaming may be able to adjust video rate based on predicted throughput, while virtual/augmented reality may cache/request information depending on predicted throughput. Some slices/applications require more accurate throughput prediction than other applications.

Some of the aforementioned input data (features) may be observed by the UE while others may be obtained by the access network through sensing by sensors coupled to the communication network or network measurements, e.g., distance of the user to mm-wave BS, and dynamic/static obstacles in the vicinity, or network analytics (analytics module generating processed data). Therefore, a split encoder-decoder model with an encoder residing in the UE unit and a decoder residing in the access network may be convenient to minimize feature exchange and enhance privacy of the users. Moreover, having a global decoder model that utilizes a global view of the scene as well as obtains data/features from multiple users can be better (more optimal) than predicting the throughput for each user individually (with local features).

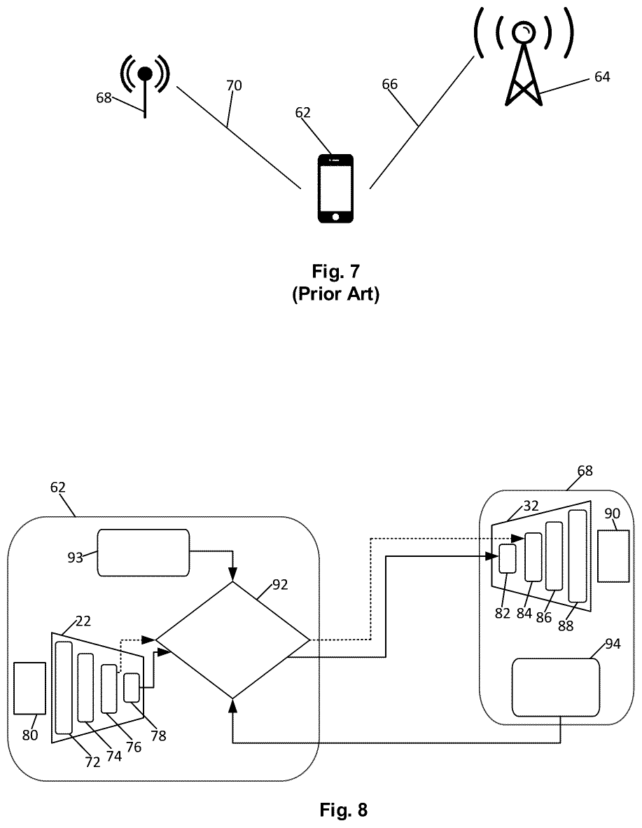

FIG. 8 shows an embodiment of a system in accordance with the present disclosure. The system of FIG. 8 comprises a UE unit 62 and a mm-wave station 68. The UE unit 62 includes an encoder 22, which comprises layers 72, 74, 76 and 78. The encoder layer 72 receives input features 80. The mm-Wave station 68 includes a decoder 32, which comprises layers 82, 84, 86 and 88. The decoder layer 88 may output a mm-wave throughput prediction 90. The UE unit 62 also comprises a decision logic module 92 that may be configured to decide to send to the decoder layer 84 or 82 respectively, the output vector of layer 76 or the output vector of layer 78, as the latent representation of the input features 80. The decision logic module 92 may receive as input data 93 (input features, input communication network features) that may identify an application running on the UE unit 62 and/or that may relate to a network slice (or performance thereof) connecting the UE unit 62 to the mm-wave station 68. The mm-wave station 68 may obtain status data 94 regarding the congestion of the access network and/or the contention of the access network. For example, the mm-wave station 68 may obtain data related to network conditions, such as whether there is congestion on the allocated C-plane band or whether some computing hardware is busy for example in a cloud radio access network resources (C-RAN). The status data 94 may be provided to the decision logic module 92 of the UE unit 62. In accordance with the data 93 related to the application/network slice and with the status data 94, the decision logic module 92 may decide which latent representation (the one from layer 76 or the one from layer 78) to provide to the decoder 32.

In other embodiments, the decision logic 92 may be deployed in a network element different from the UE unit 62, such as, for example, a controller or orchestrator in the network access side. Additionally, although the encoder-decoder connection is shown as being over the legacy C-plane connection, it can be over C-plane mm-wave based connection in the absence of a macro-BS.

In some embodiments, a network or communications network may be a core network. In other embodiments, the network or communications network may be an access network.

In embodiments, a network element may be a logical entity communicably coupled to one or more physical or logical devices. Non-limiting examples of a network element of a core network include switches, routers, commodity servers, databases, other network elements and network nodes. Non-limiting examples of a network element of an access network include user equipment, a network access tower (e.g. base station), and a mobile edge computing server.

In embodiments, an encoder network element is a network element at which the encoder is deployed. In a core network, the encoder may be deployed at a network switch, a network router, a middleware component, or a commodity server network element. In an access network, the encoder may be deployed at user equipment (e.g. a cellular phone), a network access tower (e.g. base station), or a mobile edge computing server network element.

In embodiments, a decoder network element is a network element at which the decoder is deployed. When in a core network, the decoder may be deployed at a network switch, a network router, a middleware component including commercial-off-the-shelf computing hardware platforms and specialized hardware computing platforms, or a commodity server network element, or a data center network element, or at any other suitable core network apparatus or device. When in an access network, the decoder may be deployed at a user equipment (e.g., mobile device), or a network access tower (e.g. base station), which may include a baseband unit, a middleware component including commercial-off-the-shelf computing hardware platforms and specialized hardware computing platforms, a commodity server, a mobile-edge computing server, or a data center, or at any other suitable access network apparatus or device.

In embodiments, non-limiting examples of a network or application function include: traffic forecasting (prediction), traffic classification, traffic forwarding, anomaly detection, traffic conditioning, queue management, packet scheduling, input data reconstruction and other network or application functions implementable in the network. A network or application function relies on various network function features (or parameters) in order to perform its intended functionality. Such features may be predefined for each network or application function. For example, a traffic forecasting function may rely on the following features: packet rate, bandwidth, time-dependence of network traffic, traffic fluctuations.

A quality of operation of the network or application function (or a performance of the decoder in supporting the network or application function or operation thereof) may vary in response to how informative is the latent representation obtained by the decoder. If the predictive performance of the decoder fails to meet a pass criteria (e.g., lower quality or resolution than needed for the network or application function), for example, as a result of network congestion, then the quality of operation of the network or application function (or a performance of the decoder in supporting the network or application function or operation thereof) may be decreased in response.

A network or application function may rely on some features that are substantially constant and may be preset (e.g. traffic capacity restrictions, cell capacity and QoS requirements). The network or application function may rely on some features that can change abruptly, for example, as a result of maintenance downtime, network disruption or an update. The network or application function may rely on some features that may fluctuate or change over time, such as data flow, packet rate, packet size, and inter-arrival rate. Time resolution of data (representative of or including some or all network or application function features) obtained at an encoder network element may substantially match a time granularity at which a network or application function operates. For example, packet-level network or application functions, such as rate shaping and scheduling, typically operate at finer time granularity (e.g. picoseconds to milliseconds), whereas a traffic forecasting network function typically operates at a coarser time granularity (e.g. seconds to hours).

A notable aspect in embodiments of the present disclosure is the notion of adjusting the size (or size; e.g. in bits) of a latent representation in response to at least one performance metric (or a performance metric value representative thereof). The size/length of the latent representation may be adjusted by generating the latent representation at a specific (or selected) encoder NN layer.

In embodiments, the size/length of the latent representation may be decreased to lower a signaling overhead associated with transfer of the latent representation from the encoder to a decoder. A latent representation of smaller size/length would require fewer (e.g. communication, bandwidth) network resources to be transferred across the network from the encoder network element to a decoder network element.

In embodiments, in an encoder having a plurality of encoder NN layers, each subsequent encoder NN layer, starting with the encoder input layer, may generate an output vector with a size (length or size) that is less than or (at most) equal to the previous encoder NN layer. For example, for an encoder having 1 through N encoder NN layers, an output vector of layer N-5 is the input vector of the subsequent layer N-4. The NN layer N-4 outputs a corresponding output vector of layer N-4 having a length less than or equal to the length of the output vector of layer N-5. Thus, a latent representation generated at layer N-4 has a length less than or equal to the length of a latent representation generated at layer N-5.

In embodiments, at least one encoder may be deployed at a respective encoder network element after training, for example, with an associated at least one decoder. Each encoder may have a number of encoder NN layers optimized (e.g. through training) to generate or result in generating such latent representation from which each associated decoder, receiving the latent representation, can produce a prediction.

In embodiments, the length or size of the latent representation, or a corresponding latent vector output by a corresponding or selected encoder NN layer, may have a direct impact on (e.g. communication, bandwidth) resource consumption cost associated with sending or transferring the latent representation from the encoder network element to the (at least one) decoder network element.

In embodiments, a decoder has a number of decoder NN layers. Each decoder NN layer can receive a latent representation of an associated length corresponding to each decoder NN layer. A decoder NN layer to receive a specific latent representation may be selected based, for example, on the size/length of the specific latent representation.

In embodiments, the decoder NN layer receiving the (specific) latent representation (i.e., the destination decoder NN layer) may be determined by the decoder network element configured accordingly, by an orchestrator discussed elsewhere herein, by a latent representation module deployed at the decoder network element, or by a combination thereof. Determining which decoder NN layer is to receive the latent representation may be based, for example, on a latent representation indication indicative of a selected encoder NN layer at which the specific latent representation was generated by the encoder. The indication may be a tag provided to the decoder network element. As will be understood by the skilled worker, in some embodiments, the tag may be provided in a data frame or in a control frame. For example, if the tag is implemented for a network or application function, then the tag may be provided in a control frame. As another example, if the tag is provided at the application layer, the tag may be provided in a data frame. In some embodiments, the tag may identify the destination decoder NN layer. In other embodiments, the tag may identify the size of the latent representation and the decoder network element may have a mapping indicating which decoder NN layer is to receive latent representations of the identified size. Thus, the decoder may receive the specific latent representation (or concatenated latent representation) at the selected decoder NN layer based (at least in part) on the latent representation indication. In some embodiments, the determination of which decoder NN layer is to receive the latent representation may be made by determining the size of the latent representation and by identifying the decoder NN layer that is configured to receive an input vector that has the same size as the latent representation.

In an embodiment, the selected decoder NN layer may be directly correlated (or in direct correspondence) with the selected encoder NN layer. For example, the size of the latent representation (output vector) generated at the selected encoder NN layer is equal to the size of the latent representation (input vector) received by the decoder at the selected decoder NN layer.

In some embodiments, an encoder may output (generate) a latent representation R having a size (length) L. The latent representation may be compressed to obtain a compressed latent representation cR with compressed size cL. The compression process may be a loss compression process. A decoder associated to the encoder may be configured to obtain and decode the compressed latent representation cR to perform a TE related function. In further embodiments, an encoder may output (generate) a latent representation R having a size (length) L. The latent representation may be expanded to obtain an expanded latent representation eR with an expanded size eL. The expansion process may be an appending process where another latent representation (e.g., that adds information or explicit features) is appended to eR. A decoder associated to the encoder may be configured to obtain and decode eR to perform a TE related function. For such embodiments, instead of simply training an encoder-decoder system, it may be required to train the encoder-process (compression or expansion)-decoder system.

In embodiments, the latent representation indication, indicative of the selected encoder NN layer at which the specific latent representation was generated, may be generated at the decoder network element receiving the specific latent representation, for example by the decoder network element or by the latent representation module.

In embodiments, the latent representation indication, indicative of the selected encoder NN layer at which the specific latent representation was generated, may be a part of the specific latent representation, for example, as a corresponding tag or notification attached to or combined with the specific latent representation.

In an embodiment, the latent representation indication may be generated by the encoder as part of or subsequent to generating the specific latent representation.

In an embodiment, the latent representation indication may be generated by the encoder network element and combined with or attached to the specific latent representation configured accordingly and, for example, before sending the specific latent representation to the (each of the associated at least one) decoder network element.

In an embodiment, the latent representation indication may be generated by an orchestrator. The orchestrator may obtain or receive the latent representation indication from the encoder or the encoder network element. The orchestrator may determine, based on the latent representation indication, the decoder NN layer to receive the specific latent representation, and provide (e.g, send, transmit) a corresponding indication of the selected decoder NN layer to the decoder, a latent representation module or the decoder network element. The decoder may receive the specific latent representation at the selected decoder NN layer based (at least in part) on such corresponding indication.

In embodiments, a latent representation, generated at an encoder layer X, may have a greater size compared to the size of an optimized latent representation generated at another consecutive NN encoder layer Y. The latent representation generated at encoder layer Y has less information than the latent representation generated encoder layer X. The resulting obtained network or application function features may have higher quality or resolution as a result of being obtained from a latent representation that is less encoded and includes or carries more information therein. This may contribute to increased performance of the network or application function operation and, therefore, increased performance of the decoder in performing or enabling such (at least one) network or application function.

In embodiments, a latent representation having greater length may be generated at an encoder NN layer N′ preceding the encoder layer N associated with an optimized latent representation, for example, based, at least in part, on at least one performance metric value.

In embodiments, such performance metric value may be indicative of a decrease in the predictive performance of the decoder. The encoder may, for example, receive a corresponding decoder performance indication when the performance of the decoder is below a predetermined threshold.

In embodiments, a latent representation Csub, generated at an additional at least one consecutive encoder NN layer Nsub, has smaller length compared to the length of an optimized latent representation C and, therefore, carries less information therein. This may contribute to lower predictive performance by the decoder. Nevertheless, a decrease in signaling overhead associated with sending a such latent representation from an encoder network element to a decoder network element may outweigh the associated decrease in the predictive performance of the decoder. For example, in a scenario of increased network congestion, receiving a sub-optimal latent representation may be preferential to not receiving any latent representation or receiving it with a delay.

The resulting obtained predictive performance of the decoder may be lower because of being obtained from a latent representation that is more encoded (or deeper unnecessarily) and includes or carries fewer information therein. This may result in decreased operating performance of the network or application function and, therefore, decreased performance of the decoder in performing or enabling such (at least one) network or application function.

In embodiments, a latent representation having smaller length may be generated at any additional encoder NN layer Nsub following the encoder layer N associated with an optimized latent representation, for example, based, at least in part, on at least one performance metric value indicative of network performance. In embodiments, such performance metric value may include an indication of a network failure in meeting a performance criteria. Such performance criteria may be indicative, for example, of the available network resources or available bandwidth at an associated communications link between the encoder network element sending the latent representation and the decoder network element receiving the latent representation for transmission of the latent representation therebetween. In another example, the performance criteria may be indicative of a general congestion (e.g. a critical decrease in performance or available resources) in the network, at the associated communications link, at the encoder network element, at the decoder network element, or a combination thereof.

In embodiments, in response to such indication of the network failure in meeting the performance criteria, the encoder may generate a sub-optimal latent representation Csub at the additional at least one encoder NN layer Nsub. The sub-optimal latent representation Csub has a reduced associated signaling overhead and, therefore, contributes (at least in part) to the network meeting the performance criteria by using fewer resources.

In embodiments, one or more performance metric values may be obtained by an orchestrator (or controller) deployed at the network. The orchestrator may be configured to obtain at least one performance metric value representative or indicative of at least one or a combination of: a performance of the network, and a predictive performance of the decoder. Based on the obtained one or more performance metric values, the orchestrator may determine to adjust the length of the latent representation. Adjusting the length of the latent representation may be initiated to adjust the signaling overhead or resource consumption cost associated with sending the latent representation from an encoder network element to a decoder network element. Adjusting the length of the latent representation may result in corresponding adjustment or change (e.g. increase) in the performance of the decoder.

In embodiments, adjusting the length of the latent representation may be needed in response to both a decrease in decoder performance, potentially requiring a correspondingly greater length of the latent representation, and a decrease in network performance, potentially requiring a smaller length of the latent representation (e.g. to decrease associated signaling overhead). In this case, the adjusted length of the latent representation, and the corresponding (i.e. selected) encoder NN layer at which it is to be generated, may be determined (e.g. by the orchestrator) using optimization methods.

In various embodiments, and more generally, the orchestrator (or another component configured accordingly) may make decisions in order to minimize (globally or locally) or limit a cost function, or equivalently maximize (globally or locally) or provide for an adequately high objective function. The decisions may further be made in such that one or more hard or soft constraints are satisfied. Thus, the orchestrator may solve or approximately solve an optimization problem. The decision variables of the optimization problem can represent various performance metric values, discussed herein, such as those indicative of decoder performance or network performance, or the like, or a combination thereof. Various approaches for solving or approximately solving an optimization problem may be used, as will be readily understood by a worker skilled in the art.

In embodiments, a system of encoders and one or more decoders associated with each encoder and receiving (e.g. via corresponding encoder and decoder network elements) latent representations therefrom may be deployed in the network. Each encoder may send, via an associated encoder network element at which it is deployed, its latent representation to one or more decoders (or respective decoder network elements). A decoder network element may receive more than one latent representation, for example, from each associated encoder network element. The decoder network element may, periodically or substantially continuously, concatenate (or combine, or fuse) some or all latent representations it receives into a single latent representation for the decoder deployed at the decoder network element. Such concatenating may be performed by a latent representation module or another (e.g. concatenating) module deployed at the decoder network element.

In embodiments, the concatenated latent representation may have at least the same length as the smallest length of its constituent latent representations. The concatenated latent representation may be received by the decoder at a selected decoder NN layer as described elsewhere with regard to a latent representation. Some or all features of a latent representation and actions associated therewith in the present disclosure can be applied to the concatenated latent representation. For example, the decoder NN layer to receive the concatenated latent representation may be determined by the decoder network element configured accordingly, by the orchestrator discussed elsewhere herein, by the latent representation module deployed at the decoder network element, or a combination thereof. Such determining may be based at least on the length of the concatenated latent representation.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method, comprising:
at a first network element of a communication network, the first network element including a neural network (NN) encoder having NN encoder layers each configured to generate a respective output vector:
obtaining at least one performance value;
determining, in accordance with the at least one performance metric value, which of the NN encoder layers to use as an output layer of the NN encoder, the output vector of the output layer being a latent representation of input data input at the first network element;
generating, with the NN encoder using the determined NN encoder layer as the output layer, the latent representation; and
providing the latent representation to a second network element of the network, the second network element including a NN decoder configured to decode the latent representation to perform at least one network or application function, the at least one performance value including at least one of:
a performance metric value indicative of a performance of the communication network;
a predictive performance of the decoder in performing the at least one network or application function;
a performance requirement of a slice of the communication network connecting the first network elements to the second network element; and
a performance requirement of an application running on the first network element or the second network element.

2. The method of claim 1, wherein the at least one performance metric value indicative of the performance of the communication network includes at least one of:
a utilization rate of a link of the communication network,
a utilization rate of a wireless channel of the communication network,
a measured contention for wireless access resources of the communication network,
a delay associated to the communication network, and
a congestion of the communication network.

3. The method of claim 1, wherein determining which NN encoder layer to use as the output layer depends on a size of the respective output vector.

4. The method of claim 1, wherein the NN decoder has NN decoder layers, the method further comprising providing the latent representation as input to one of the NN decoder layers that has a same size as the output layer of the NN encoder.

5. The method of claim 4, wherein the one of the NN decoder layers that has the same size as the output layer of the NN encoder also has a same depth as the determined output layer of the encoder.

6. The method of claim 4, wherein the NN decoder decodes the latent representation to do at least one of:
obtain a prediction,
obtain a classification, and
reconstruct at least some of the input data to obtain reconstructed input data.

7. The method of claim 6, wherein the communication network is controlled in accordance with at least one of:
the prediction,
the classification, and
the reconstructed input data.

8. The method of claim 1, further comprising:
at an additional network element of the communication network, the additional network element including an additional NN encoder having additional NN encoder layers each configured to generate a respective output vector:
obtaining at least one additional performance metric value;
determining, in accordance with the at least one additional performance metric value, which of the additional NN encoder layers to use as an output layer of the additional NN encoder, the output vector of the output layer of the additional NN encoder being an additional latent representation of additional input data at the additional network element;
generating, with the additional NN encoder using the determined additional NN encoder layer as the output layer of the additional NN encoder, the additional latent representation;
providing the additional latent representation to the second network element, the second network element being configured to decode the additional latent representation.

9. A method comprising:
obtaining, by a first network element of a communication network having an encoder with neural network (NN) encoder layers, input data at the first network element;
generating, by the encoder, at one of the NN encoder layers, a latent representation of the input data;
providing, by the first network element, the latent representation to a second network element of the communications network, the second network element having a decoder with NN decoder layers;
receiving, by the decoder the latent representation at a NN decoder layer that has a same size as the NN encoder layer that generated the latent representation; and
decoding, by the decoder, the latent representation.

10. The method of claim 9, wherein the NN decoder decodes the latent representation to do at least one of:
obtain a prediction,
obtain a classification, and
reconstruct at least some of the input data to obtain reconstructed input data.

11. The method of claim 10, wherein the communication network is controlled in accordance with at least one of:
the prediction,
the classification, and
the reconstructed input data.

12. The method of claim 9, further comprising:
obtaining, by the first network element, performance values, the performance values including at least one of:
a performance metric value indicative of a performance of the communication network;
a predictive performance of the decoder in decoding the latent representation;
a performance requirement of a slice of the communication network connecting the first network elements to the second network element; and
a performance requirement of an application running on the first network element or the second network element; and
selecting the one of the NN encoder layers to generate the latent representation, in accordance with the performance values.

13. The method of claim 12, wherein the at least one performance metric value indicative of the performance of the communication network includes at least one of:
a utilization rate of a link the communication network,
a utilization rate of a wireless channel of the communication network,
a measured contention for wireless access resources of the communication network,
a delay associated to the communication network, and
a congestion of the communication network.

14. The method of claim 12, wherein said generating the latent representation by the encoder, at the selected encoder NN layer, in response to said receiving the decoder performance indication, results in a change in the predictive performance of the decoder.

15. The method of claim 13, wherein the performance metric value indicative of the performance of the network comprises an indication of a failure of the communication network in meeting a performance criteria, said generating the latent representation, by the encoder, at the selected encoder NN layer, in response to said indication of the network failure in meeting the performance criteria, resulting in the network approaching the performance criteria.

16. The method of claim 12, further comprising:
computing, by an orchestrator deployed at the communications network, at least one performance metric value representative of at least one or a combination of: a performance of the network, and the predictive performance of the decoder;
providing, by the orchestrator to the encoder network element, an indication of the selected encoder NN layer based on the least one performance metric value; and
generating, by the encoder, the latent representation at the selected encoder NN layer based at least in part on the indication of the selected encoder NN layer.

17. The method of claim 16, wherein said computing, by the orchestrator, the at least one performance metric value comprises receiving a decoder performance indication when the predictive performance of the decoder fails to meet a predetermined threshold.

18. The method of claim 17, wherein generating the latent representation by the encoder, at the selected encoder NN layer, in response to said indication of the selected encoder NN layer, results in an adjustment of the predictive performance of the decoder to meet the predetermined threshold.

19. The method of claim 16, wherein the performance metric value indicative of the performance of the network comprises an indication of the network failure in meeting a performance criteria, said generating the latent representation, by the encoder, at the NN decoder layer that has the same size as the NN encoder layer that generated the latent representation, in response to said indication of the selected encoder NN layer, resulting in the network meeting the performance criteria.

20. The method of claim 11, wherein obtaining the performance measurements comprises:
obtaining the performance measurements from at least one or a combination of: the first network element, the second network element, and another network element.
